(19) United States
(12) Patent Application Publication
(10) Pub. No.: US 2009/0083781 A1
(43) Pub. Date: Mar. 26, 2009

(54) Intelligent Video Player

(75) Inventors: Linjun Yang, Beijing (CN); Xian-Sheng Hua, Beijing (CN); Shipeng Li, Beijing (CN)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 11/859,334

(22) Filed: Sep. 21, 2007

(51) Int. Cl. H04H 20/00; H04N 7/00

(52) U.S. Cl. 725/20

(57) ABSTRACT

Systems and methods for managing digital video data are described. The digital video data maybe managed by employing a computing device to extract metadata from the video file and calculate a unique video signature associated with the video file. The computing device then uploads the metadata and unique video signature to a server which stores the metadata in a lookup table according to the unique video signature.

### BACKGROUND

With the advent of inexpensive video players and the sharing of video files over the internet, there has been a dramatic increase in the amount of digital video content available for viewing.

Most computing devices such as personal computers, desk top computers and hand held devices, have software that allows the user to play, record, and edit digital video files (e.g., Microsoft's Windows Media Player™ and Real Network's RealPlayer™). For example, a viewer can down load a video file from one of may online video content providers and watch the video from their laptop computer or hand held device in the convenience of their home or while traveling.

In addition, a number of software tools have been developed to help viewers organize and play their digital videos. These tools include play lists, and video browsing, and seeking programs which enable easy access to the digital videos and enhance the viewers viewing experience. Play lists allow the viewer to customize their media experience by specifying which video files to play. While video browsing and seeking allow a user to quickly grasp the meaning of a video by providing the viewer access to the various video frames without viewing the entire video.

One issue with play lists, and video browsing and seeking programs, however, is that the host computer is required to analyze the video file and archive the processed data for later use. This can create a problem for inexpensive digital video recording and viewing devices which may have limited computing power and storage capacity. One solution is to add computational power and storage capability to these video players, however this would significantly increase the players cost.

A second issue is that portable video players must analyze the video file before employing the various software tools. This delay creates a time burden and inconvenience for the viewer.

Accordingly, there is a need for a better method of managing and playing digital video files.

### SUMMARY

This summary is provided to introduce systems and methods for managing digital video, which are further described below in the Detailed Description. This summary is not intended to identify the essential features of the claimed subject matter, nor is it intended for determining the scope of the claimed subject matter.

In an implementation, video data is managed by extracting metadata from the video data, calculating a unique video signature that is associated with the video data and storing the metadata in a lookup table residing on a server according to the unique video signature.

In another implementation, video data is managed by selecting video data to play on a computing device, calculating a unique video signature that is associated with the video data, downloading metadata residing on a server using the unique video signature, and playing the selected video data on the computing device using the metadata.

### BRIEF DESCRIPTION OF THE DRAWINGS

The teachings herein are described with reference to the accompanying figures. In the figures, the left-most reference number digit(s) identifies the figure in which the reference number first appears. The use of the same reference numbers in different figures indicates similar or identical items.

FIG. 1 depicts an illustrative system for managing video data.

FIG. 2 depicts an illustrative computing device for playing digital video files.

FIG. 3 depicts a series of key frames associated with portions of a video file.

FIG. 4 depicts an illustrative graphical user interface for displaying video data in accordance with an embodiment.

FIG. 5 depicts an illustrative graphical user interface for displaying video data in accordance with an embodiment.

FIG. 6 depicts an illustrative graphical user interface for tagging a video file in accordance with another embodiment.

FIG. 7 depicts an illustrative lookup table in accordance with an embodiment.

FIG. 8 is a block diagram illustrating a method for managing video data in accordance with an embodiment.

FIG. 9 is a block diagram illustrating a method for managing video data in accordance with a further embodiment.

### DETAILED DESCRIPTION

Systems and methods for managing digital content, such as digital video files, are described. As noted, current video players employ play lists, and video browsing and seeking programs to help viewers organize, find, and play their digital video files. However, the video player is currently required to analyze the video file, extract the needed data, and archive the data for current or future use by the viewer. This can be problematic for inexpensive digital video viewing devices which typically have limited computational power and storage capacity. Moreover, this creates a time burden and an inconvenience for the viewer.

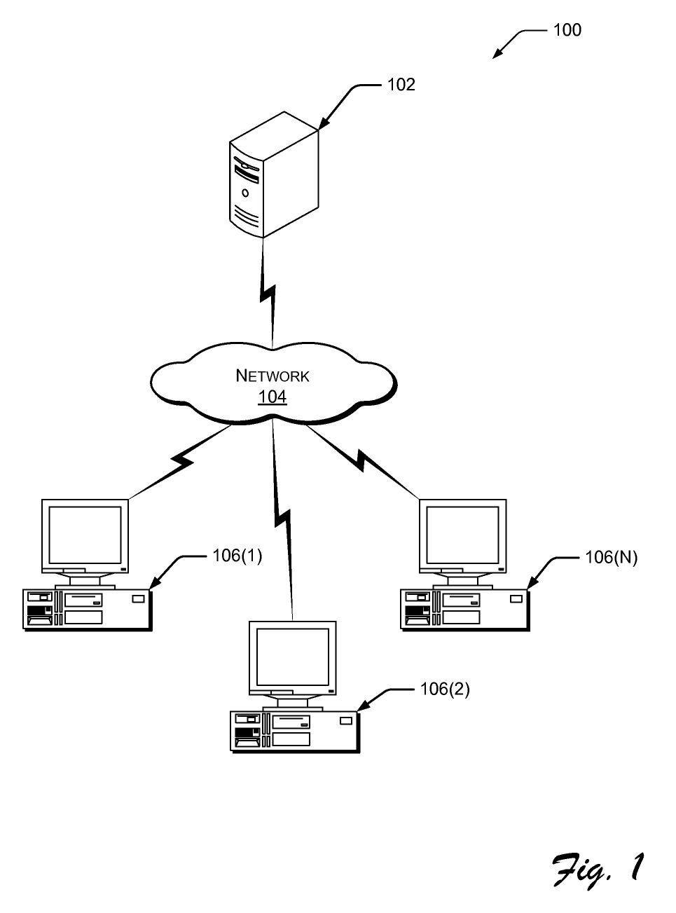

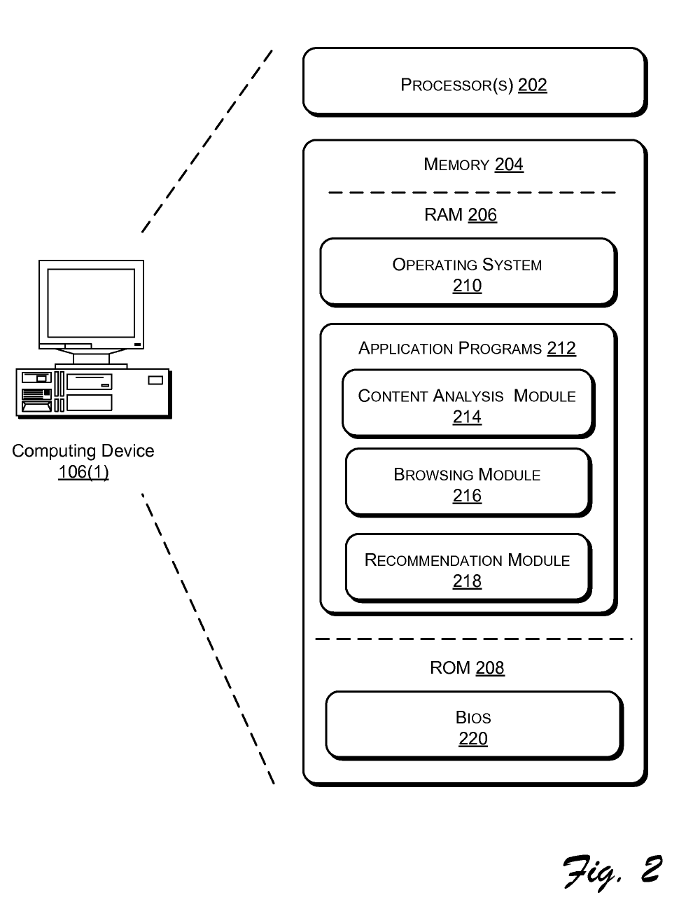

With this in mind, FIG. 1 illustrates an illustrative system 100 for managing video data in accordance with an embodiment. It is specifically noted that while the following discussion describes techniques applied to video files, these techniques may also be applied to other types of medial files such as audio files, animations, slide shows, and/or any other types of media files. The system 100 includes a server 102, a network 104 and one or more computing devices 106 (1)-(N) for processing and playing the video data. The network 104 could be a local area network (LAN), and may couple a limited number of personal computers and a single server, which is spread throughout a home, business or company. Alternately, the network 104 could be a wide area network (WAN), such as the Internet, and may couple millions of computing devices, various servers, and span the world.

The server 102 provides server and storage services for the computing device(s) 106 via the network 104. The server 102 may include one or more computer processors capable of executing computer-executable instructions. For example, the server 102 may be a personal computer, a work station, a main frame computer, a network computer or any other suitable computing device.

The computing device 106, meanwhile could be a laptop computer, a desktop computer, a notebook computer, a personal digital assistant, a set top box, a game console, or other suitable computing device. The computing devices 106(1)-(N) may be coupled to the data network 104 through a wired or a wireless data interface.

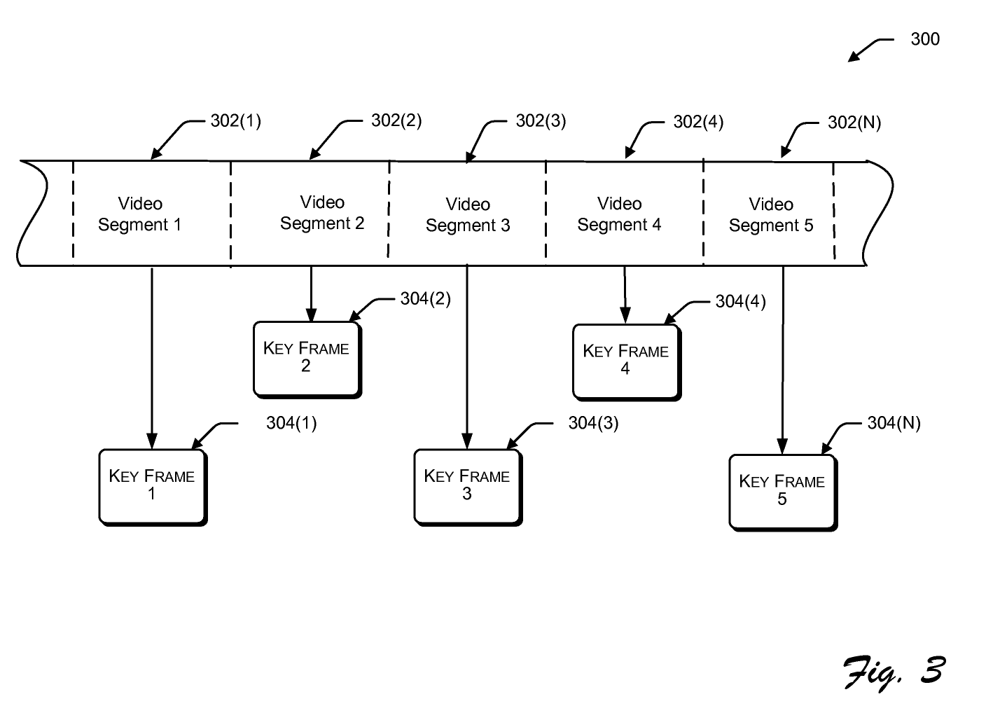

Having described the system 100 for managing digital video data, the discussion now shifts to the computing device 106. FIG. 2 depicts an illustrative computing device 106, which can be used to implement the techniques described herein. The components of the computing device 106 may include one or more processors 202, a system memory 204, and a system bus (not shown) that couples various system components together.

The computing device 106 may also include a variety of computer readable media including volatile memory, such as random access memory (RAM) 206, and non-volatile memory, such as read only memory (ROM) 208. A basic input/output system (BIOS) 220 which contains the basic routines for transferring information between elements of the computing device 106, is stored in ROM 208. The data and/or program modules that are currently being used by the processors 202 are also stored in RAM 206.

The computing device 106 may also include other computer storage media such as a hard drive, a magnetic disk drive (e.g., floppy disks), an optical disk drive (e.g., CD-ROM, DVD, etc.) and/or other types of computer readable media, such as flash memory cards.

A viewer can enter commands and information into the computing device 106 via a variety of input devices including: a keyboard and a pointing device (e.g., a “mouse”). The user may view the video data via a monitor or other display device that is connected to the system bus via an interface, such as a video adapter.

As noted, the computing device 106 operates in a networked environment using logical connections to one or more servers 102. As noted, the computing device 106 and server 102 may be coupled through a local area network (LAN) or a wide area network (WAN). Such networking environments are commonplace in offices, enterprise-wide computer networks, intranets, and the Internet.

Any number of program modules can be stored in memory 204 including an operating system 210, one or more application programs 212, and program data (not shown). Each of the operating system 210, application programs 212, and program data (or some combination thereof) may implement all or part of the components that support the distributed file system.

Generally, program modules include: routines, programs, objects, components, data structures, etc., that perform particular tasks. In this case, there is a content analysis module 214, a browsing module 216 and a recommendation module 218.

The content analysis module 214, analyzes the selected video file and extracts the video's metadata. The metadata is used by viewers to organize, summarize, and search for video files. The content analysis module 214 also analyzes the selected video file to extract the key frames that describe the various scenes of the video. Lastly, the content analysis module 214 includes a video signature function which calculates a unique signature value associated with the selected video.

The filmstrip browsing module 216, includes an intelligent progress bar which presents the key frames in a hierarchical format while the video file is being played, allowing the viewer to select and view particular video scenes. This functionality is illustrated and described in detail below.

Lastly, the recommendation module 218, allows the viewer to tag or provide comments regarding a particular video file. The tags are then presented to the viewer, or later viewers to aid them in selecting video files for viewing. It should be appreciated that the functionality of the content analysis 214, filmstrip browsing 216, and tagging 218 modules may be combined or distributed to ensure the functionality of the network 100.

With these modules in mind, the following is a brief discussion regarding the key frames of a video file. Key frames provide viewers with a dynamic overview of a video file and allow them to select specific portions or a particular scene of the video. The computing device 106 may detect the key frames using a shot detection algorithm which analyzes the video file for content changes and determines which frames are key frames. Alternatively, the video provider may include labels or metadata in the video file identifying the key frames (e.g., label or table of contents). In addition, the key frames may be spaced at prescribed intervals throughout the video file (e.g., every 30-60 seconds), thereby allowing the computing device to simply use time to identify the key frames.

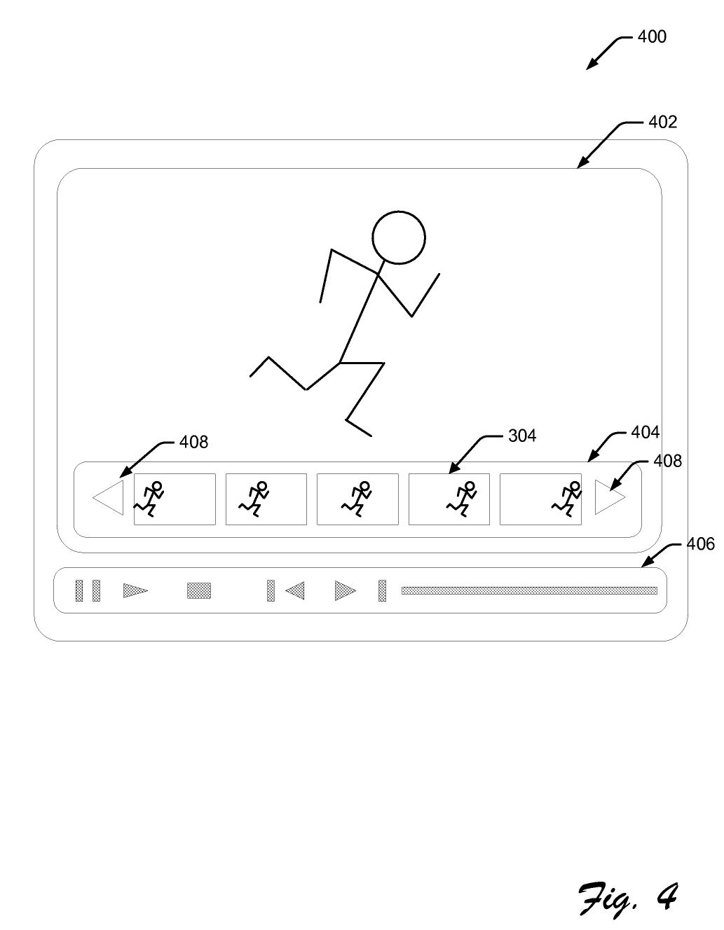

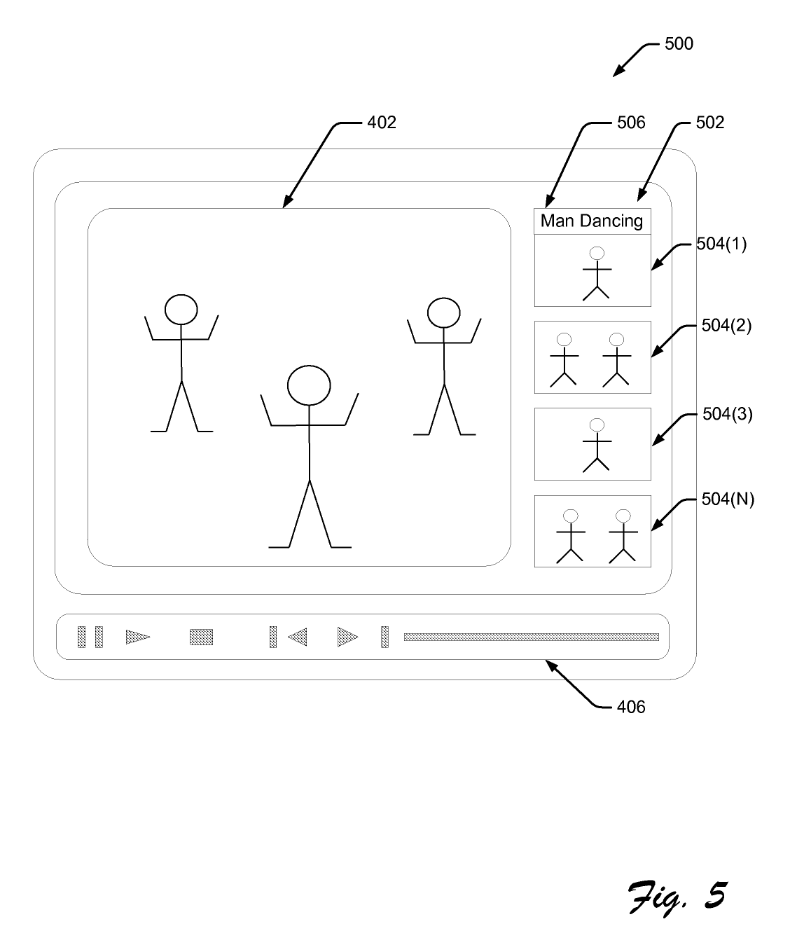

FIG. 3, illustrates a video file 300 as a continuous linear tape. Generally, video files 300 are not indexed or labeled to identify the key shots, scenes, or segments. So, when a viewer accesses an un-indexed video file 300 using their computing device 106, the content analysis module 214 must analyze and index the video file in a hierarchical browsing structure. In an illustrative embodiment, the content analysis module 214 extracts key frames 304(1)-(N) representing the video segments 302(1)-(N) of the video file 300. For example, key frames 1 and 2 are extracted from video segments 1 and 2 respectively, and are presented to the viewer in a hierarchical browsing structure, as described below with reference to FIG. 4.

FIG. 4, depicts an illustrative graphical user interface 400 for displaying video data in accordance with an embodiment. The interface 400 includes a display area 402 for displaying the video file being played, a hierarchal display of the key frames 304(1)-(N) (e.g., filmstrip) 404, and a control interface 406 for controlling operation of the video player.

The control interface 406 contains as series of buttons for pausing, playing, fast forwarding, and reversing the video, along with a status bar to indicate the playing time or the video frames being played, along with amount of play time that remains.

As noted, key frames 304 provide an overview of the video file 300 being played and provide a means of quickly scrolling through the video file 300. The key frames 304 are displayed as a filmstrip 404 at the bottom of the display area 402, and are depicted as a hierarchy of 5 key frames 304. However, it should be appreciated, that a greater or lesser number of key frames 304 could be displayed. Additionally, the filmstrip 404 could be displayed in different locations in the display area 402 (e.g., top, bottom or sides of the display area 402), with the location depending on the viewer's preference.

The filmstrip 404 also includes buttons 408 allowing the viewer to browse, scroll, fast forward or backup through the various key frames 304. When the viewer has found a key frame 304 or segment of the video that they would like to view, the viewer simply selects that key frame 304 and the video display 402 indexes to and plays that particular key frame 304.

Once a viewer has found a video file that they enjoy, they may want to view similar or related video files. FIG. 5, depicts an illustrative graphical user interface 500 for enabling viewers to locate and/or view similar or related video files. As illustrated, the interface 500 includes a display area 402, a control interface 406, and a recommended video window 502. The recommended video window 502 may includes a series of recommended video icons 504(1), (2), . . . (N).

The recommended video window 502 provides viewers with an enhanced viewing experience by recommending similar or related video files. When the viewer moves their mouse or pointing device over a recommended video icon 504, such as icon 504(1), a description 506 of the video is displayed. The description 506 may include the video's title, a summary or description, comments, or other information regarding the video file. When the viewer clicks on the recommended video icon 504, a motion thumbnail of the corresponding video will be played. While FIG. 5 illustrates the description 506 as comprising text, other embodiments may include video, audio, animation, a hyperlink, or any other type of data capable of describing the corresponding video.

Additionally, while FIG. 5 illustrates four video icons 504(1)-(2), it should be appreciated that a greater or lesser number of video icons 504 could be displayed and they could be displayed in different locations in the display area 402 (e.g., top, bottom or left side of the interface 500). Once the viewer has reviewed the image or consumed (e.g., read, watched, listened to, etc.) the description 506, they may select the recommended video by, for example, clicking on the corresponding video icon 504.

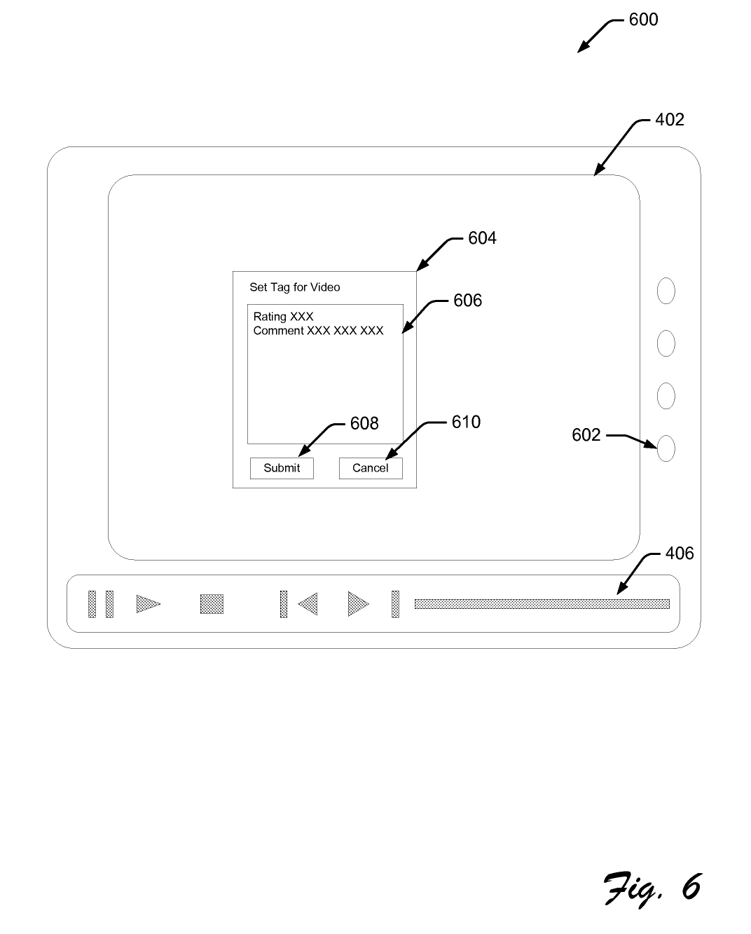

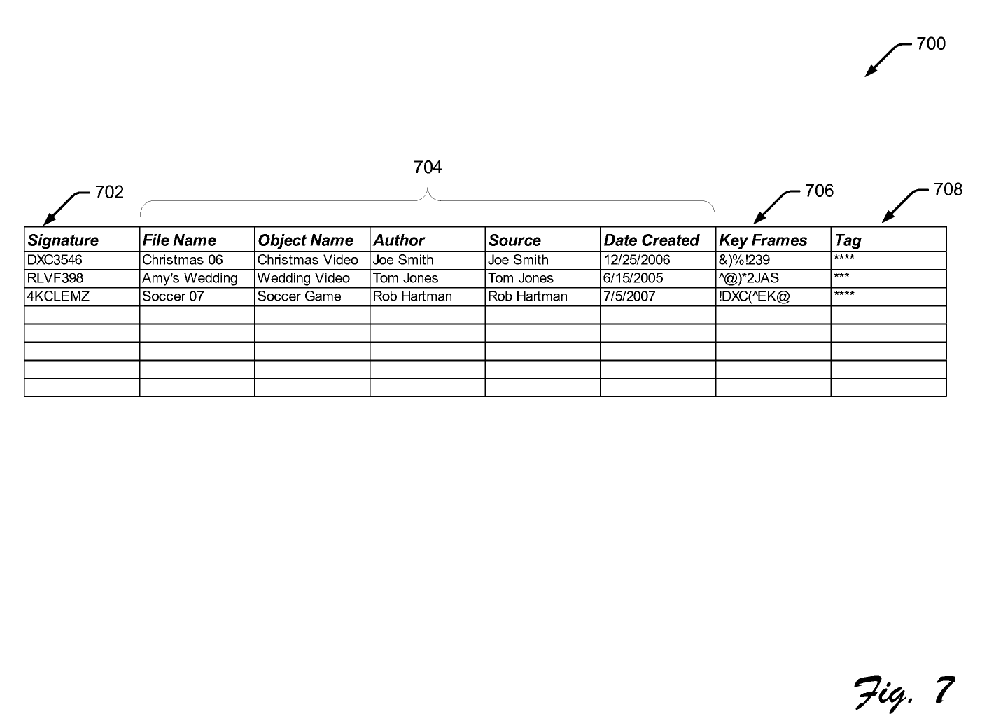

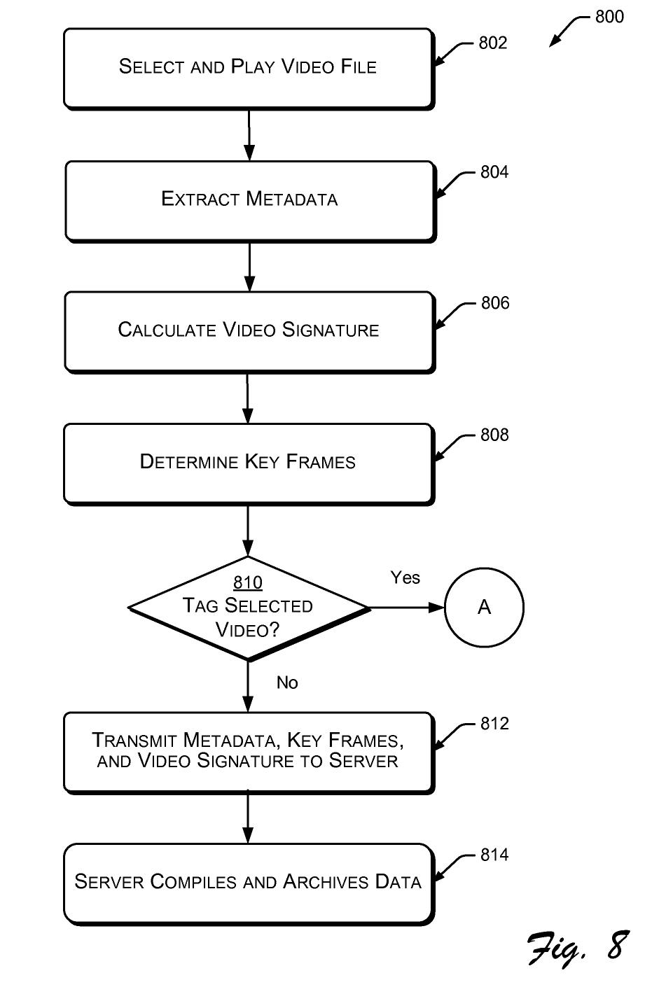

Once a viewer has watched a video file, the they may want to provide comments or tags so that the system 100 may recommend other video files for the viewers to watch. To achieve this end, FIG. 6 depicts an illustrative exemplary graphical user interface 600 to enable viewers to recommend, or comment on a video file. The interface 600 includes a display area 402, a control interface 406, and a “tagging” button 602 for providing recommendations or comments.

When a viewer selects the “tagging” button 602 with, for example a mouse or pointing device, a tagging window 604 opens in the display area 402. The viewer then enters their comments and/or recommendations in a window 606, and selects a “Submit” button 608. Alternatively, the viewer may decide against providing a recommendation and/or comments or may decide to start over. In this instance they select a “Cancel” button 610 to cancel the inputted recommendation and/or comments.

When providing comments, the viewer may note the quality of the video file from their personal perspective. For example, the viewer may assign to the video file a numerical score (e.g., 1 through 10), a letter score (e.g., A, B, C, D, and F), a star rating (e.g., 1 to 4 stars), words indicative of quality (e.g., excellent, good, medium, fair, poor, etc.), and/or other suitable means of indicating the quality of the video file. Once the viewer enters and submits the recommendation and/or comments, this tagging information is uploaded to the server 102 where it is compiled and archived.

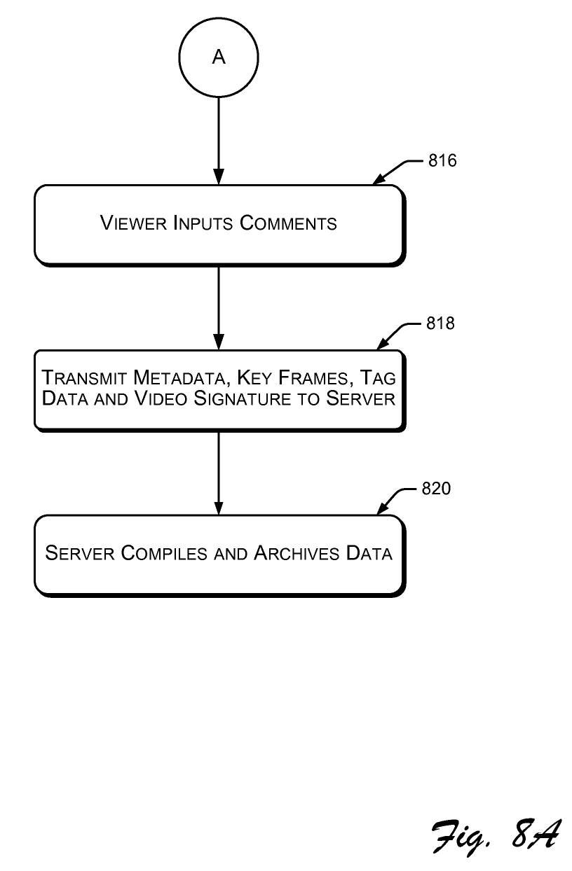

Once the computing device 106 has gathered the metadata, key frame, and tag data, it is ready to be uploaded to the server 102. When the server 102 receives this data, it stores this information in a data base structure, for example a lookup table, as described and illustrated below with reference to FIG. 7.

FIG. 7, depicts an illustrative lookup table 700 for archiving video data. The lookup table 700 resides on the server 102 and contains unique video signatures 702, metadata 704, key frames 706, and tag data 708.

The server 102 uses the unique video signatures 702 to index and search for the video file data. In one embodiment the computing device 106 calculates the video signature by uniformly extracting 128 bytes from the video file and combining it with the 4 byte file length to create the video signature 702.

In an alternate embodiment, the video signature 702 is a hash value derived from the video file. A hash table is a data structure that associates a key (e.g., a person's name) with a specific value(s) (e.g., the person's phone number), allowing for the efficient looking up of the specific value(s). Hash tables work by transforming the key (e.g., the person's name) with a hash function to create a hash value (e.g., a number used to index or locate data in a table). For example, the computing device 106 picks a hash function h that maps each item x (e.g., video metadata) to an integer value h(x). The video metadata x is then archived according to integer value h(x) in the lookup table 700.

Once the video signature 702 is calculated, the computing device 106 uses the video signature 702 to either archive or retrieve the specific video file's metadata 702, key frames 714, and/or tag data 716.

The video metadata 704 may include anything that describes the video file. This may include the files name (e.g., Christmas06.MPEG), an object name (e.g., name of the subject), an author's name (e.g., photographer's name), the source of the video file (e.g., person who uploaded the video), the date and time the file was created (e.g., YYYYMMDD format), or other useful video metadata.

As noted, key frames 304 represent the various segments of a video file 300 and may include a shot, scene, or sequence. In this case, the key frames locations 706 are archived so that a portable computing device 106 can display the key frames 304 without having to analyze the particular video file.

The lookup table 700 also includes the tag data 708 (e.g., comments and recommendations) that previous viewers have made regarding the video file. As noted, tag data 708 may include comments, recommendations, and/or an indicator of the video file's quality. The tag data 708 may also include a description or key words that could help a viewer sort or search for the video file.

Having described the system 100 for managing video data, an illustrative computing device 106, and several illustrative graphical user interfaces 400, 500 and 600, the discussion now shifts to methods for managing video data.

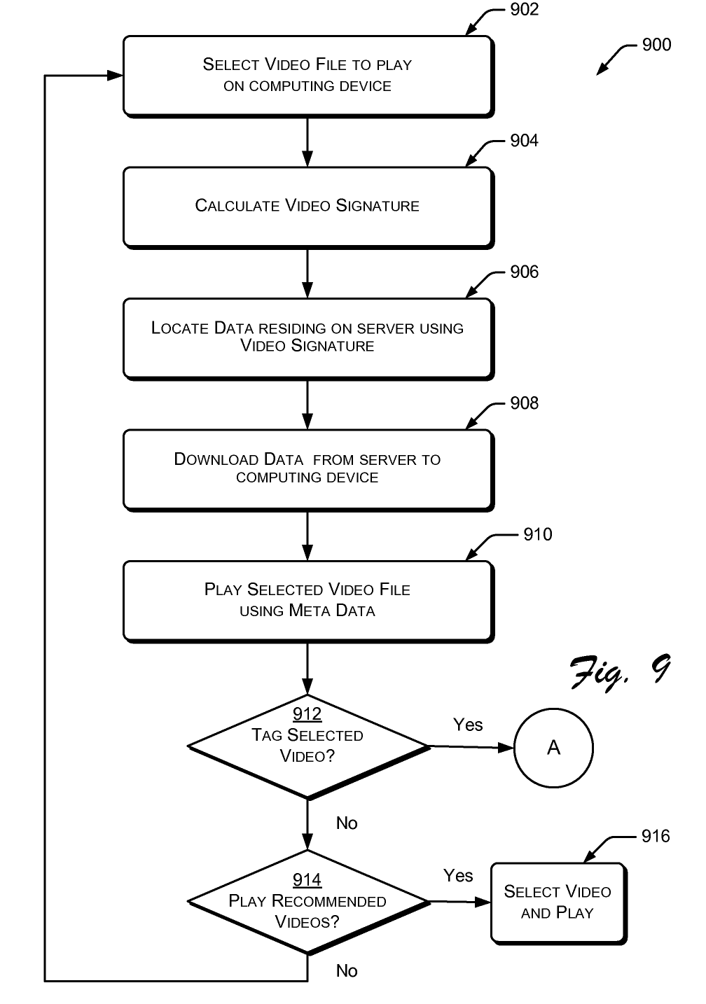

FIG. 8 depicts an illustrative process 800 for managing video data in accordance with an embodiment. The process 800 is illustrated as a collection of blocks in a logical flow graph, which represents a sequence of operations that can be implemented in hardware, software, or a combination thereof. In the context of software, the blocks represent computer instructions that, when executed by one or more processors, perform the recited operations.

The process 800 begins with the viewer selecting and preparing to play a video file on their computing device 106, at block 802. The computing device 106 then extracts any metadata 704 associated with the video file 300, at block 804. As described in detail above, metadata is data about data. Accordingly, the metadata 704 could be the file's name, a description of the video (e.g., subject, location, keywords, captions, etc.), the author of the file, the source of the file, the date the file was created, copyright information, or any other metadata that may be of interest to a viewer. The metadata 704 may be embedded in the video file through an Extensive Markup Language (XML) header. In these instances, the personal computing device 106 retrieves the metadata 704 by simply reading the XML header attached to the video file 300.

Once the metadata 704 has been extracted from the video file 300, the computing device 106 calculates a unique signature value 702 for the video file, at block 806. The video signature 702 maybe determined by uniformly extracting 128 bytes for the physical file and combining it with the 4 byte file length. Alternatively, the signature value 702 could be calculated using a hash function.

Once the video signature 702 is calculated, the computing device 106 determines the video's key frames 304, at block 808. As noted, key frames 304 represent the various segments of a video file 300, and may include a specific video shot, video scene, and/or video sequence. The computing device 106 using a shot detection algorithm detects the shot, scene, and/or sequence changes within the video file and stores the respective segments as key frames 304. There are a number of different approaches for detecting key frames 304. Fundamentally, a cut detection algorithm compares the images of two consecutive frames and determines whether the frames differ significantly enough to warrant reporting a scene transition. The cut detection algorithm could be based on: (1) color content differences between consecutive frames; (2) a scoring approach in which consecutive frames are given a score representing the probability that a cut is between the frames; or (3) a threshold approach in which consecutive frames are filtered with a threshold value and the pair of frames with a score higher than the threshold is considered a cut. While a few illustrative examples have been provided, the computing device 106 may employ other approaches to detect key frames 304.

Once the key frames 304 have been determined, the viewer has the opportunity to tag the video file, at block 810. Tag data 708 may include words or symbols indicating the video's quality, search terms or key words that may help viewers search for the video file 300, or any other comment the viewer chooses to make. If the viewer chooses to tag the video file, then the process proceeds to block 816 as illustrated in FIG. 8A. The viewer tags the video file 300 by selecting the “tagging” button 602. Selecting this button opens up window 604, within which the viewer may enter their comments and/or recommendations. The viewer then enters their comments and/or recommendations in the comment window 606, and selects “Submit” to enter the data, at block 816.

Once the video file 300 has been tagged, the metadata 704, key frames 706, tag data 708, and video signature 702 are uploaded to the server 102 via the network 104, at block 818. The server 102 then sorts and/or compiles the data, and archives it in the lookup table 700, at block 820.

Alternatively, if the viewer decides not to tag the video file 300, the process proceeds to block 812. Here, the metadata 704, key frames 706, and video signature 702 are uploaded to the server 102 via the network 104. Again, the server 102 receives the data, sorts and/or compiles the data, and archives it in the lookup table 700, at block 814.

Having described how video data is uploaded to the server 102, the discussion now shifts to how other viewers may access the video data residing on the server.

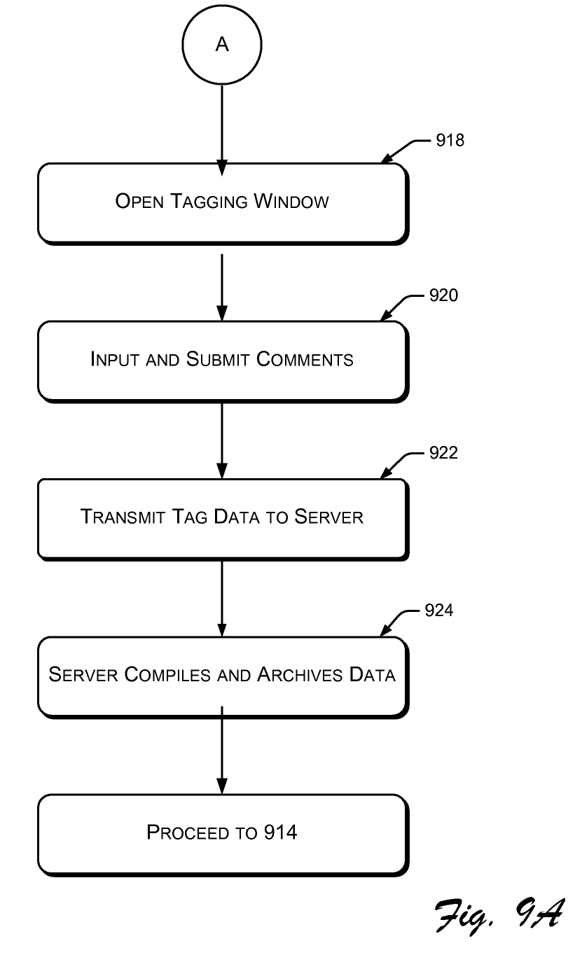

With this in mind, FIG. 9 depicts an illustrative process 900 to enable viewers to access the video data on the server 102. At block 902, the viewer selects a video file 300 to play on their computing device 106.

The computing device 106 then calculates the video files 300 unique signature value 702 by, for example, uniformly extracting 128 bytes from the video file and combining it with the 4 byte file length, at block 904. Alternatively, the signature value 702 could be calculated using a hash function, or any other suitable method.

Using the video file's 300 unique signature 702, the commuting device 106 and/or server 102 searches the lookup table 700 for the data associated with the video file 300 (e.g., metadata, key frames, tag data), at block 906. Once the data has been found, the data is downloaded to, or otherwise received by, the computing device 106, at block 908.

The computing device 106 then plays the selected video file 300 using the metadata 704, at block 910. The computing device 106 may display the key frames 304 as a film strip 404 to provide the viewer with an overview of the video and a means of quickly scrolling through the video file. Alternatively, the computing device 106 may display a list of recommended videos 502.

Once the video has been played, or alternatively while the video is being played, the viewer may comment on or tag the video, at block 912. If the viewer chooses to comment on or tag the video at block 912, the process 900 moves to FIG. 9A. The viewer selects the “tagging” button 602, causing the tagging window 604 to open in the display area 402, at block 918. The viewer then enters their comments into the tagging window 604, and selects the “Submit” button 608, at block 920. The comments are uploaded from the computing device 106 to the server 102 via the network 104, at block 922. The server then compiles and archives the tag data 708 in the look-up table 700 under the video file's unique signature 702, at block 924.

After viewing the selected video, the viewer may decide to view the recommended video files, at block 914. The viewer selects the recommended videos by, for example, moving their mouse or pointing device over the video icon 504, and clicking on the image, at block 916.

While several illustrative methods of managing video data have been shown and described, it should be understood that the acts of each of the methods may be rearranged, omitted, modified, and/or combined with one another.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of managing video data comprising:
playing video data on a computing device;
extracting metadata from the video data;
calculating a unique video signature that is associated with the video data; and
transmitting the metadata and the video signature to a server, wherein the server stores the metadata in a lookup table according to the unique video signature.

2. The method of claim 1, wherein the metadata comprises at least one of a file name, an object name, an author, a video source, or a creation date.

3. The method of claim 1, wherein the unique video signature is calculated by uniformly extracting 128 bytes from the video file and combining it with a 4 bite file length.

4. The method of claim 1, wherein the unique video signature is calculated by a hash function.

5. The method of claim 1, wherein the computing device comprises a laptop computer, a desktop computer, a personal digital assistant, a set top box, a cellular phone or a portable computing device.

6. The method of claim 1, further comprising:
determining at least one key frame associated with the video data; and
transmitting data designating the at least one key frame to the server.

7. The method of claim 1, further comprising:
tagging the video data to create tag data; and
transmitting the tag data to the server.

8. A method of managing video data comprising:
selecting video data to be played on a computing device;
calculating a unique video signature that is associated with the video data;
receiving metadata from a server, wherein the metadata is stored in a lookup table according to the unique video signature; and
playing the selected video data on the computing device using the metadata.

9. The method of claim 8, wherein the unique video signature is calculated by uniformly extracting 128 bytes from the video file and combining it with a 4 bite file length.

10. The method of claim 8, wherein the unique video signature is calculated by a hash function.

11. The method of claim 8, wherein the metadata comprises a file name, an object name, an author, a video source, a creation date, a key frame or tag data.

12. The method of claim 8, wherein the personal computing device comprises a laptop computer, a desktop computer, a personal digital assistant, a set top box, a cellular phone or a portable computing device.

13. The method of claim 8, further comprising tagging the selected video data with a word or symbol indicating a quality of the selected video data.

14. The method of claim 8, further comprising:
playing recommended video data based on the selected video data's metadata or tag data.

15. A system for managing video data comprising:
a computing device, wherein the computing device extracts metadata from the video data, calculates a unique video signature that is associated with the video data, and transmits the metadata and the unique video signature to a server, wherein the server stores the metadata in a lookup table according to the unique video signature.

16. The system of claim 15, wherein the computing device comprises a laptop computer, a desktop computer, a personal digital assistant, a set top box, a cellular phone or a portable computing device.

17. The system of claim 15, wherein the metadata comprises at least one of: a file name, an object name, an author, a video source, or a creation date.

18. The system of claim 15, wherein the computing device determines at least one key frame associated with the video data and transmits data identifying the at least one key frame to the server.

19. The system of claim 15, wherein the computing device receives tag data associated with the video data and transmits the tag data to the server to be stored in the lookup table according to the unique video signature.

20. The system of claim 15, further comprising a server for storing the metadata according to the unique video signature and a network for transmitting the metadata and unique video signature from the computing device to the server.
